(19) United States
(12) Patent Application Publication
(10) Pub. No.: US 2014/0122550 A1
(43) Pub. Date: May 1, 2014

(54) SYSTEM FOR NONPARAMETRIC ENTROPY ESTIMATION

(71) Applicant: Zhiyi Zhang, Charlotte, NC (US)

(72) Inventor: Zhiyi Zhang, Charlotte, NC (US)

(21) Appl. No.: 13/666,515

(22) Filed: Nov. 1, 2012

(51) Int. Cl. G06F 17/16

(52) U.S. Cl. CPC G06F 17/16
USPC 708/200

(57) ABSTRACT

The claimed invention discloses method, systems, and computer program products for providing nonparametric entropy estimation. The method comprises receiving a sample having a sample size of two or more symbols; calculating a number of distinct symbols in the sample, where the sample has one or more distinct symbols; calculating a relative frequency for each of the one or more distinct symbols; calculating, for a plurality of pairs having a first and second value, a set of numerical terms for each pair; calculating, based on the plurality of pairs and sets of numerical terms, one or more values for a first and second matrix; calculating, based on the first and second matrices, a plurality of vector components for a first, second, and third vector; and calculating an entropy estimation based at least partially on the one or more components in the third vector.

### BACKGROUND

For years, in information theory, entropy has been used as a central measurement of information. Traditionally, data processing units have been used to accept a sample of values and produce estimation of entropy as the output. Entropy estimators are crucial elements in bioinformatics, genomics, signal processing, image analysis, neural sciences such as neural computation, networks analysis such as real-time network anomaly detection, cryptography, query logs in web search, graph estimation, and the like. Outcomes may observe numerical information such as survival times, temperatures, purity of air, stock prices, inflation rates, and the like. Outcomes may also observe symbolic information such as words in text, shapes of objects, types of genes, types of terrorist tactic, and the like. During the last 60 years, many entropy estimators have been developed. The majority of these estimators are modified versions of the plug-in estimator. These estimators have slowly decaying biases. In many important cases, these estimators' biases decay at a rate comparable to 1/n, where n is the sample size.

Therefore a need exists for an entropy estimator which has a bias that decays faster, such as a bias that decays exponentially with respect to n, where n is the sample size. A much faster decay of the bias results in a more accurate estimation, which in turn leads to an earlier and a more accurate detection of the signals in applications.

### BRIEF SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In one embodiment, an apparatus for nonparametric entropy estimation is provided, the apparatus may comprise a memory, a processor, and a module stored in the memory, executable by the processor. In some embodiments, the module may be configured to receive a sample having a sample size of two or more symbols. In some embodiments, the module may be configured to calculate a number of distinct symbols in the sample, where the sample has one or more distinct symbols. In some embodiments, the module may be configured to calculate a relative frequency for each of the one or more distinct symbols.

In some embodiments, the module may be configured to calculate a set of numerical terms for a plurality of pairs having a first and second value, where the set of numerical terms may be calculated for each pair. In such an embodiment the first value may be an integer. In such an embodiment, the integer may be a value greater than or equal to one. In such an embodiment, the integer may be a value less than the sample size. In some embodiments, the second value may be an integer. In such an embodiment the integer may be a value greater than or equal to one. In such an embodiment, the integer may be a value less than or equal to the number of distinct symbols in the sample.

In some embodiments, the module may be configured to calculate a third value for each of the plurality of pairs, where the third value may be denoted as at least one value in a first matrix. In some embodiments the third value may be a numerical value. In such embodiments, the third value may be equal to the product of the terms in the numerical set of terms for each respective pair. In some embodiments, the number of rows in the first matrix may be a value equal to the sample size minus one. In some embodiments, the number of columns in the first matrix may be a value equal to the number of distinct symbols in the sample.

In some embodiments, the module may be configured to calculate one or more fourth values for each column in the first matrix, where a fourth value may be calculated for each value in the column, and where the fourth value may be denoted as at least one value in a second matrix. In some embodiments, the fourth value may be a numerical value. In such embodiments, the fourth value may be equal to the product of a value in the column multiplied by the relative frequency for the value with respect to the second value in a related pair. In some embodiments, the number of rows in the second matrix may be a value equal to the sample size minus one. In some embodiments, the number of columns in the second matrix may be a value equal to the number of distinct symbols in the sample.

In some embodiments, the module may be configured to calculate a fifth value for each row in the second matrix, where the fifth value may be denoted as at least one value in a first vector, and where the vector has one or more components. In some embodiments, the fifth value may be numerical value. In such an embodiment, the fifth value may be equal to the sum of the values in the row. In some embodiments, the number of rows in the first vector may be a value equal to the sample size minus one. In some embodiments, the number of columns in the first vector may be equal to one.

In some embodiments, the module may be configured to calculate a sixth value for each component in the first vector, where the sixth value may be denoted as at least one value in a second vector, and where the second vector has one or more components. In some embodiments, the sixth value may be a numerical value. In some embodiments, a component of the first vector may be a numerical value. In such embodiments, the sixth value may be equal to the product of the component of the first vector multiplied by a scalar value relative to the first value. In some embodiments, the scalar value may be a numerical value. In such an embodiment, the scalar value may be equal to the product of a series of terms. In some embodiments, the number of rows in the second vector may be a value equal to the sample size minus one. In some embodiments, the number of columns in the second vector may be equal to one.

In some embodiments, the module may be configured to calculate a seventh value for each component in the second vector, where the seventh value may be denoted as at least one value in a third vector, and where the third vector has one or more components. In some embodiments, the seventh value may be a numerical value. In some embodiments a component of the second vector may be a numerical value. In such an embodiment, the seventh value may be equal to the component divided by the first value with respect to a relative pair. In some embodiments, the number of rows in the third vector may be a value equal to the sample size minus one. In some embodiments, the number of columns in the third vector may be equal to one.

In some embodiments, the module may be configured to calculate an entropy estimation based at least partially on the one or more components in the third vector. In some embodiments, the one or more components in the third vector may be numerical values. In such an embodiment, the entropy estimation may be equal to the sum of the components in the third vector.

In one embodiment, a method for nonparametric entropy estimation, the method may comprise receiving a sample having a sample size of two or more symbols; calculating a number of distinct symbols in the sample, where the sample has one or more distinct symbols; calculating a relative frequency for each of the one or more distinct symbols; calculating, for a plurality of pairs having a first and second value, a set of numerical terms for each pair; calculating a third value for each of the plurality of pairs, where the third value may be denoted as at least one value in a first matrix; calculating one or more fourth values for each column in the first matrix, where a fourth value may be calculated for each value in the column, and where the fourth value may be denoted as at least one value in a second matrix; calculating a fifth value for each row in the second matrix, where the fifth value may be denoted as at least one value in a first vector, and where the vector has one or more components; calculating a sixth value for each component in the first vector, where the sixth value may be denoted as at least one value in a second vector, and where the second vector has one or more components; calculating a seventh value for each component in the second vector, where the seventh value may be denoted as at least one value in a third vector, and where the third vector has one or more components; and calculating an entropy estimation based at least partially on the one or more components in the third vector.

In one embodiment, a computer program product for nonparametric entropy estimation may be provided, the computer program product may comprise a non-transitory computer-readable medium comprising a set of codes for causing a computer to receive a sample having a sample size of two or more symbols; calculate a number of distinct symbols in the sample, where the sample has one or more distinct symbols; calculate a relative frequency for each of the one or more distinct symbols; calculate a set of numerical terms for a plurality of pairs having a first and second value, where the set of numerical terms may be calculated for each pair; calculate a third value for each of the plurality of pairs, where the third value may be denoted as at least one value in a first matrix; calculate one or more fourth values for each column in the first matrix, where a fourth value may be calculated for each value in the column, and where the fourth value may be denoted as at least one value in a second matrix; calculate a fifth value for each row in the second matrix, where the fifth value may be denoted as at least one value in a first vector, and where the vector has one or more components; calculate a sixth value for each component in the first vector, where the sixth value may be denoted as at least one value in a second vector, and where the second vector has one or more components; calculate a seventh value for each component in the second vector, where the seventh value may be denoted as at least one value in a third vector, and where the third vector has one or more components; and calculate an entropy estimation based at least partially on the one or more components in the third vector.

### BRIEF DESCRIPTION OF THE SEVERAL VIEWS OF THE DRAWINGS

The present embodiments are further described in the detailed description which follows in reference to the noted plurality of drawings by way of non-limiting examples of embodiments of the present embodiments in which like reference numerals represent similar parts throughout the several views of the drawings and wherein:

FIG. 1 provides a flow chart illustrating a process for nonparametric entropy estimation.

### DETAILED DESCRIPTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for implementing gift card association. An exemplary system is configured to receive a dataset and output a positive numerical value which may be considered an estimate of an unobservable quantity such as entropy. It should be noted that the terms “entropy”, “Shannon's entropy”, and/or “Shannon's information entropy” may be used interchangeably throughout the specification.

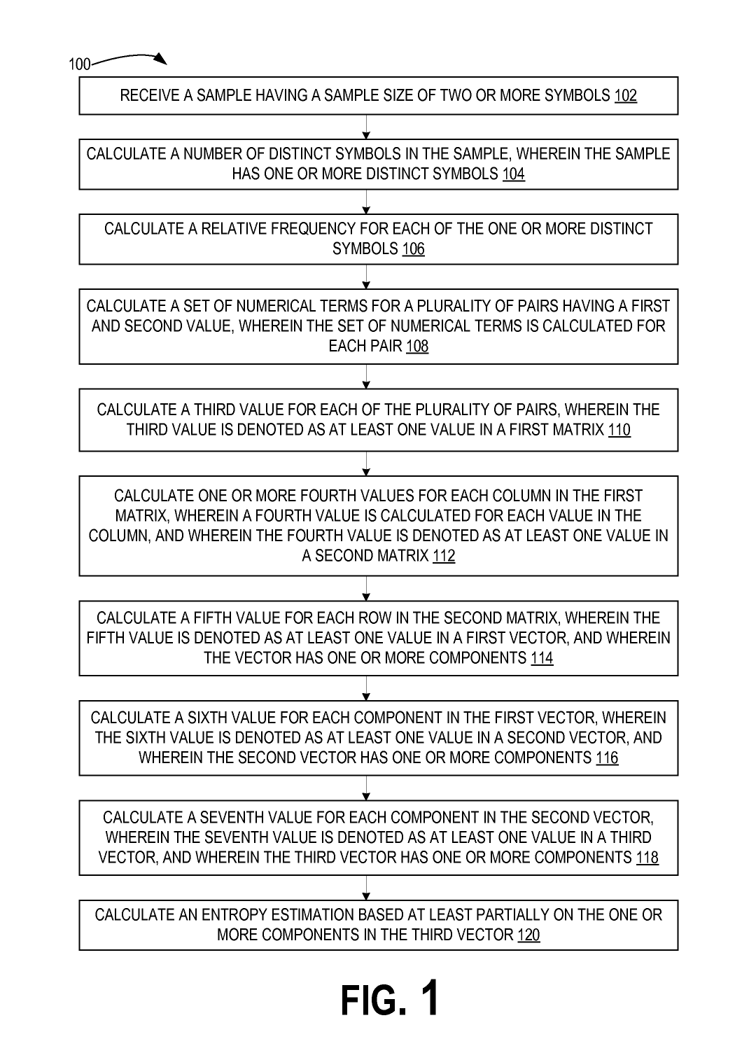

Now referring to FIG. 1, a flow chart illustrating a process for nonparametric entropy estimation is presented. At event 102, the system receives a sample or data set. It should be noted that the terms “sample” and “data set” may be used interchangeably throughout the specification. The sample may comprise a set of symbols or values. It should also be noted that the terms “symbol” and “value” may be used interchangeably throughout the specification. The symbols in the sample may represent either symbolic or numerical values. The size of the sample, also referred to as the sample size, may be indicated by the number of data pieces in the sample. The sample size may be a positive integer. In some embodiments, the sample size may be any integer greater than or equal to 2. In some embodiments the sample size may be denoted by the variable n. It should be noted that the phrase “sample size” and the variable “n” may be used interchangeably throughout the specification. For example, the sample may be denoted by the following notation x₁, x₂, . . . , xₙ, such that n (n≧2).

In one embodiment, the values in the sample may be different. In other embodiments, the values in the sample may be the same. In any instance there exist a number of distinct values in the sample. At event 104, the system calculates the number of distinct symbols in the sample. In some embodiments the number of distinct values in the sample may be denoted by the variable K. It should be noted that the phrase “number of distinct symbols in the sample” and the variable “K” may be used interchangeably throughout the specification. The number of distinct symbols in the sample may indicate the number of distinct values, symbolic or numerical in the data set. In one embodiment, the number of distinct values in the sample is calculated by counting the distinct values, symbolic or numerical, in the sample. In such an embodiment, the value K may be an integer value.

At event 106, the system calculates the relative frequency for each of the distinct symbols in the sample. It should be noted that the terms “relative frequency”, “proportion”, “sample proportion”, and/or “percent” may be used interchangeably throughout the specification. In some embodiments, the number of distinct values may be indexed. In some embodiments a distinct value within the sample may be denoted by the variable k, such that k, k=1, 2, . . . , K. In such an embodiment, the k^{th} distinct value may refer to a particular value that appeared in the sample. In one embodiment, the system calculates the relative frequency for each of the distinct symbols in the sample by dividing the frequency of the distinct value by the sample size to yield a numerical result. The numerical result is representative of the relative frequency. The frequency of a distinct value may refer to the number of times the distinct value appeared in the data set. In some embodiments, the frequency of the distinct value may be denoted by the variable yₖ. It should be noted that the phrase “frequency of distinct value” and the variable “yₖ” may be used interchangeably throughout the specification. In some embodiments, the relative frequency with respect to a distinct value k may be denoted by the variable \hat{p}ₖ. Thus in an exemplary embodiment \hat{p}ₖ=yₖ/n such that there is one percentage value for each of the distinct values in the sample. For example, one may have K percentage values denoted by \hat{p}₁, \hat{p}₂, . . . , \hat{p}ₖ.

At event 108, for a plurality of pairs having a first and second value the system calculates a set of numerical terms for each pair. The first value may be an integer greater than or equal to one and less than the sample size minus one (e.g., 1≦v≦n−1). In some embodiments the first value may be denoted by the variable v, such that v=1, 2, . . . , n−1. It should be noted that the term “first value” and the variable “v” may be used interchangeably throughout the specification. The second value may be an integer greater than or equal to one and less than the number of distinct values in the sample plus (e.g., 1≦k≦K+1). In some embodiments the second value may be equivalent to a distinct value in the sample and thus denoted by the variable k, such that k=1, 2, . . . , K. It should be noted that the terms “second value”, “distinct value”, and the variable “k” may be used interchangeably throughout the specification.

The set of numerical terms may comprise a plurality of terms with respect to any pair of values (v,k). The set of numerical terms may comprise a first term, one or more intermediate terms, and a last term. In some embodiments, the first term within the set of numerical terms is equal to one minus the relative frequency with respect to k (e.g., 1−\hat{p}ₖ). In some embodiments, an intermediate term is equal to one minus the relative frequency minus an incrementing integer divided by the sample size (e.g.,

$$1 - {\hat{p}}_{k} - \frac{i}{n} \text{)} .$$

Thus, in an embodiment with one or more intermediate terms, the intermediate terms may be denoted by

$$( 1 - {\hat{p}}_{k} - \frac{i}{n} ) , ( 1 - {\hat{p}}_{k} - \frac{i + 1}{n} ) , ( 1 - {\hat{p}}_{k} - \frac{i + 2}{n} )$$

In some embodiments the incrementing integer may be denoted by the variable i. The incrementing integer may be a positive integer greater than or equal to one and less that the first value minus one (e.g., 1≦i≦v−1). The value of the incrementing integer is relative to the position of the intermediate term within the set of numerical terms. In one embodiment, the initial incrementing integer contained within the first intermediate term within the set of numerical terms is equal to 1, such that for each of the following intermediate terms the incrementing integer is one plus the previous incrementing integer (e.g., i_{current}=iₚᵣₑᵥᵢₒᵤₛ+1). For example, for the first intermediate term, which follows the first term within the set of numerical terms, the incrementing integer is equal to 1. Likewise, for the next intermediate term, which follows the first intermediate term, the incrementing integer is equal to 2. In some embodiments, the last term is equal to one minus the relative frequency minus, the first value minus 1 divided by the sample size (e.g.,

$$1 - {\hat{p}}_{k} - \frac{v - 1}{n} \text{)} .$$

In an exemplary embodiment, the set of numerical terms may be denoted by

$$( 1 - {\hat{p}}_{k} ) , ( 1 - {\hat{p}}_{k} - \frac{1}{n} ) , ( 1 - {\hat{p}}_{k} - \frac{2}{n} ) , … , ( 1 - {\hat{p}}_{k} - \frac{v - 1}{n} ) .$$

At event 110, for the plurality of pairs having a first and second value the system calculates the product of terms in the set of numerical terms for each pair. The first value may be an integer greater than or equal to one and less than the sample size minus one (e.g., 1≦v≦n−1). The second value may be an integer greater than or equal to one and less than the number of distinct values in the sample plus (e.g., 1≦k≦K).

The product of the terms in the set of numerical terms with respect to any pair of values (v,k) may yield a numerical value. Calculating the product of the terms in the set of numerical terms may comprise multiplying a first term with, one or more intermediate terms, and a last term. In some embodiments, the first term within the set of numerical terms is equal to one minus the relative frequency with respect to k (e.g., 1−\hat{p}ₖ). In some embodiments, an intermediate term is equal to one minus the relative frequency minus an incrementing integer divided by the sample size (e.g.,

$$1 - {\hat{p}}_{k} - \frac{i}{n} \text{)} .$$

In some embodiments, the last term is equal to one minus the relative frequency minus, the first value minus 1 divided by the sample size (e.g.,

$$1 - {\hat{p}}_{k} - \frac{v - 1}{n} \text{)} .$$

In an exemplary embodiment, the set of numerical terms may be denoted by:

$$( 1 - {\hat{p}}_{k} ) \times ( 1 - {\hat{p}}_{k} - \frac{1}{n} ) \times , … , \times ( 1 - {\hat{p}}_{k} - \frac{v - 1}{n} ) .$$

In some embodiments the product of the terms in the set of numerical terms with respect to any pair of values (v,k) may be denoted by the variable A_{v,k}. Each product result may be denoted in a first matrix. It should be noted that the terms “matrix” and “data table” may be used interchangeably throughout the specification. The number of numerical values in the first matrix may be equal to the sample size minus one, multiplied by the number of distinct values in the sample (e.g., (n−1)XK). The number of rows in the first matrix may be equal to the sample size minus one (e.g., n−1). The number of columns in the first matrix may be equal to the number of distinct values in the sample, K. In an exemplary embodiment, the first matrix may be denoted by:

$$\begin{matrix}{A}_{1 , 1} & {A}_{1 , 2} & … & {A}_{1 , K} \\ {A}_{2 , 1} & {A}_{2 , 2} & … & {A}_{2 , K} \\ ⋮ & ⋮ & ⋮ & ⋮ \\ {A}_{n - 1 , 1} & {A}_{n - 1 , 2} & … & {A}_{n - 1 , K}\end{matrix}$$

At event 112, for each column in the first matrix, the system multiplies every term in the column by \hat{p}ₖ with respect to the relative pair having a first and second value (v,k). The first value may be an integer greater than or equal to one and less than the sample size minus one (e.g., 1≦v≦n−1). The second value may be an integer greater than or equal to one and less than or equal to the number of distinct values (e.g., 1≦k≦K).

In some embodiments the product of the term in a column multiplied by \hat{p}ₖ with respect to the relative pair having a first and second value (v,k) may be denoted by the variable \hat{p}ₖXA_{v,k}. Each product result may be denoted in a second matrix. The number of numerical values in the second matrix may be equal to the sample size minus one, multiplied by the number of distinct values in the sample (e.g., (n−1)XK). The number of rows in the second matrix may be equal to the sample size minus one (e.g., n−1). The number of columns in the second matrix may be equal to the number of distinct values in the sample, K. In an exemplary embodiment, the second matrix may be denoted by expressing the terms of the products in each columns, as shown below:

$$\begin{matrix}{\hat{p}}_{1} \times {A}_{1 , 1} & {\hat{p}}_{2} \times {A}_{1 , 2} & … & {\hat{p}}_{K} \times {A}_{1 , K} \\ {\hat{p}}_{1} \times {A}_{2 , 1} & {\hat{p}}_{2} \times {A}_{2 , 2} & … & {\hat{p}}_{K} \times {A}_{2 , K} \\ ⋮ & ⋮ & ⋮ & ⋮ \\ {\hat{p}}_{1} \times {A}_{n - 1 , 1} & {\hat{p}}_{2} \times {A}_{n - 1 , 2} & … & {\hat{p}}_{K} \times {A}_{n - 1 , K}\end{matrix}$$

In another exemplary embodiment, the second matrix may be simplified and denoted by expressing result of the products in each column, as shown below:

$$\begin{matrix}{B}_{1 , 1} & {B}_{1 , 2} & … & {B}_{1 , K} \\ {B}_{2 , 1} & {B}_{2 , 2} & … & {B}_{2 , K} \\ ⋮ & ⋮ & ⋮ & ⋮ \\ {B}_{n - 1 , 1} & {B}_{n - 1 , 2} & … & {B}_{n - 1 , K}\end{matrix}$$

For example, in such an embodiment, the term \hat{p}₁XA_{1,1} may be simplified and expressed as B_{1,1}.

At event 114, for each row in the second matrix, the system sums the terms in the row to derive a single numerical value. Each resulting sum of the terms in the row may be denoted in a first vector. It should be noted that the terms “vector” and “data table” may be used interchangeably throughout the specification. The first vector may have one or more components. In one embodiment, the one or more components may be numerical values. The number of numerical values in the first vector may be equal to the sample size minus one (e.g., n−1). In such an embodiment, the first vector may be a ((n−1)X1) data table, such that there are n−1 rows and one column. In an exemplary embodiment, the first vector may be denoted by expressing the terms of the summation in each row, as shown below:

$$\begin{matrix}{B}_{1 , 1} + {B}_{1 , 2} + … + {B}_{1 , K} \\ {B}_{2 , 1} + {B}_{2 , 2} + … + {B}_{2 , K} \\ ⋮ \\ {B}_{n - 1 , 1} + {B}_{n - 1 , 2} + … + {B}_{n - 1 , K}\end{matrix}$$

In another exemplary embodiment, the first vector may be simplified and denoted by expressing result of the summation of terms in each column, as shown below:

$$\begin{matrix}\begin{matrix}{C}_{1} \\ {C}_{2}\end{matrix} \\ ⋮ \\ {C}_{n - 1}\end{matrix}$$

In one embodiment, the simplified summation of terms in each column of the first vector may be noted by the variable Cᵥ. It should be noted that the summation of any set of terms within a row of the first vector with respect to the related first value may be denoted as “Cᵥ” throughout the specification.

At event 116, for each numerical value in the first vector, the system multiplies the numerical value by a scalar value relative to the first value. The first value may be an integer greater than or equal to one and less than the sample size minus one (e.g., 1≦v≦n−1). Each resulting product of the terms in the row may be denoted in a second vector. The second vector may have one or more components. In one embodiment, the one or more components may be numerical values. The number of numerical values in the second vector may be equal to the sample size minus one (e.g., n−1). In such an embodiment, the second vector may be a ((n−1)X1) data table, such that there are n−1 rows and one column. In one embodiment, the scalar value may be the result of a product. In such an embodiment, the product may be a series of terms multiplied by one another. In one embodiment, the respective product may be defined by:

$$( \frac{n}{n - 1} ) \times ( \frac{n}{n - 2} ) \times … \times ( \frac{n}{n - v} )$$

In any instance the numbers of terms in the series of terms may vary based upon the respective first value, v, for the related numerical value. The number of terms in the series of terms may not exceed the numerical value of the first value. For example, if the numerical value has a respective first value of two (2), the series of terms will have two (2) terms

$$( \frac{n}{n - 1} ) and ( \frac{n}{n - 2} )$$

such that the value in the subtracted value in the denominator is less than or equal to the first value. In a larger series of terms the subtracted value in the denominator is an incrementing integer that is less than or equal to the respective first value (e.g., i≦v). The value of the incrementing integer is relative to the position of the term within the series of terms. In one embodiment, the initial incrementing integer contained within the first term within the series of terms is equal to 1, such that for each of the following intermediate terms the incrementing integer is one plus the previous incrementing integer (e.g., i_{current}=iₚᵣₑᵥᵢₒᵤₛ+1). For example, for the first term, which follows the first term within the series of terms, the incrementing integer is equal to 1. Likewise, for the next term, which follows the first intermediate term, the incrementing integer is equal to 2. In such an embodiment, the resulting products may be denoted in a second vector. In an exemplary embodiment, the second vector may be denoted by expressing the terms of the respective products for each row, as shown below:

$$\begin{matrix}( \frac{n}{n - 1} ) \times {C}_{1} \\ ( \frac{n}{n - 1} ) \times ( \frac{n}{n - 2} ) \times {C}_{2} \\ ⋮ \\ ( \frac{n}{n - 1} ) \times ( \frac{n}{n - 2} ) \times … \times ( \frac{n}{n - v} ) \times {C}_{2} \\ ⋮ \\ ( \frac{n}{n - 1} ) \times ( \frac{n}{n - 2} ) \times … \times ( \frac{n}{1} ) \times {C}_{n - 1}\end{matrix}$$

In another exemplary embodiment, the second vector may be simplified and denoted by expressing result of the respective products for each row, as shown below:

$$\begin{matrix}\begin{matrix}{D}_{1} \\ {D}_{2}\end{matrix} \\ ⋮ \\ {D}_{n - 1}\end{matrix}$$

At event 118, for each numerical value in the second vector, the system divides the numerical value by the respective first value to obtain a single numerical value. The first value may be an integer greater than or equal to one and less than the sample size minus one (e.g., 1≦v≦n−1). Each resulting division may be denoted in a third vector. The third vector may have one or more components. In one embodiment, the one or more components may be numerical values. The number of numerical values in the third vector may be equal to the sample size minus one (e.g., n−1). In such an embodiment, the first vector may be a (n−1)X1 data table, such that there are n−1 rows and one column. In an exemplary embodiment, the third vector may be denoted by expressing the terms of the division for each row, as shown below:

$$\begin{matrix}{D}_{1} / 1 \\ {D}_{2} / 2 \\ ⋮ \\ {D}_{n - 1} / ( n - 1 )\end{matrix}$$

In another exemplary embodiment, the third vector may be simplified and denoted by expressing result of the division for each row for each row, as shown below:

$$\begin{matrix}\begin{matrix}{E}_{1} \\ {E}_{2}\end{matrix} \\ ⋮ \\ {E}_{n - 1}\end{matrix}$$

At event 120, the system sums the numerical values in the third vector to obtain a single numerical value. The resulting numerical value may be expressed as:

Ĥ_{z}=E₁+E₂+ . . . +Eₙ₋₁

The resulting numerical value may be equated to the value of the estimator. In an exemplary embodiment, the value of the estimator is equal to the nonparametric entropy estimation of the related sample.

Any of the features described herein with respect to a particular process flow or interface are also applicable to any other process flow or interface. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software. As used herein, the term “upon” may be substituted with “in response to.”

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for nonparametric entropy estimation, the apparatus comprising:
a memory;
a processor; and
a module stored in the memory, executable by the processor, and configured to:
receive a sample having a sample size of two or more symbols;
calculate a number of distinct symbols in the sample, wherein the sample has one or more distinct symbols;
calculate a relative frequency for each of the one or more distinct symbols;
calculate a set of numerical terms for a plurality of pairs having a first and second value, wherein the set of numerical terms is calculated for each pair;
calculate a third value for each of the plurality of pairs, wherein the third value is denoted as at least one value in a first matrix;
calculate one or more fourth values for each column in the first matrix, wherein a fourth value is calculated for each value in the column, and wherein the fourth value is denoted as at least one value in a second matrix;
calculate a fifth value for each row in the second matrix, wherein the fifth value is denoted as at least one value in a first vector, and wherein the vector has one or more components;
calculate a sixth value for each component in the first vector, wherein the sixth value is denoted as at least one value in a second vector, and wherein the second vector has one or more components;
calculate a seventh value for each component in the second vector, wherein the seventh value is denoted as at least one value in a third vector, and wherein the third vector has one or more components; and
calculate an entropy estimation based at least partially on the one or more components in the third vector.

2. The apparatus of claim 1, wherein the first value is an integer, wherein the integer is a value greater than or equal to one, and wherein the integer is a value less than the sample size.

3. The apparatus of claim 1, wherein the second value is an integer, wherein the integer is a value greater than or equal to one, and wherein the integer is a value less than the number of distinct symbols in the sample plus one.

4. The apparatus of claim 1, wherein the third value is equal to the product of the terms in the numerical set of terms for each respective pair.

5. The apparatus of claim 1, wherein the number of rows in the first matrix is a value equal to the sample size minus one, and wherein the number of columns in the first matrix is a value equal to the number of distinct symbols in the sample.

6. The apparatus of claim 1, wherein the fourth value is equal to the product of a value in the column multiplied by the relative frequency for the value with respect to the second value in a related pair.

7. The apparatus of claim 1, wherein the number of rows in the second matrix is a value equal to the sample size minus one, and wherein the number of columns in the second matrix is a value equal to the number of distinct symbols in the sample.

8. The apparatus of claim 1, wherein the fifth value is equal to the sum of the values in the row.

9. The apparatus of claim 1, wherein the number of rows in the first vector is a value equal to the sample size minus one, and wherein the number of columns in the first vector is equal to one.

10. The apparatus of claim 1, wherein a component of the first vector is a numerical value, and wherein the sixth value is equal to the product of the component of the first vector multiplied by a scalar value relative to the first value.

11. The apparatus of claim 10, wherein the scalar value is equal to the product of a series of terms.

12. The apparatus of claim 1, wherein the number of rows in the second vector is a value equal to the sample size minus one, and wherein the number of columns in the second vector is equal to one.

13. The apparatus of claim 1, wherein a component of the second vector is a numerical value, and wherein the seventh value is equal to the component divided by the first value with respect to a relative pair.

14. The apparatus of claim 1, wherein the number of rows in the third vector is a value equal to the sample size minus one, and wherein the number of columns in the third vector is equal to one.

15. The apparatus of claim 1, wherein the one or more components in the third vector are numerical values, and wherein the entropy estimation is equal to the sum of the components in the third vector.

16. A method for nonparametric entropy estimation, the method comprising:
receiving a sample having a sample size of two or more symbols;
calculating a number of distinct symbols in the sample, wherein the sample has one or more distinct symbols;
calculating a relative frequency for each of the one or more distinct symbols;
calculating, for a plurality of pairs having a first and second value, a set of numerical terms for each pair;
calculating a third value for each of the plurality of pairs, wherein the third value is denoted as at least one value in a first matrix;
calculating one or more fourth values for each column in the first matrix, wherein a fourth value is calculated for each value in the column, and wherein the fourth value is denoted as at least one value in a second matrix;
calculating a fifth value for each row in the second matrix, wherein the fifth value is denoted as at least one value in a first vector, and wherein the vector has one or more components;
calculating a sixth value for each component in the first vector, wherein the sixth value is denoted as at least one value in a second vector, and wherein the second vector has one or more components;
calculating a seventh value for each component in the second vector, wherein the seventh value is denoted as at least one value in a third vector, and wherein the third vector has one or more components; and
calculating an entropy estimation based at least partially on the one or more components in the third vector.

17. The method of claim 16, wherein the first value is an integer, wherein the first value is a value greater than or equal to one, wherein the first value is a value less than the sample size, wherein the second value is an integer, wherein the second value is a value greater than or equal to one, and wherein the second value is a value less than the number of distinct symbols in the sample plus one.

18. The method of claim 16, wherein the number of rows in the first, second, and third matrix is a value equal to the sample size minus one, and wherein the number of columns in the first, second, and third matrix is a value equal to the number of distinct symbols in the sample.

19. The method of claim 16, wherein the number of rows in the first, second, and third vector is a value equal to the sample size minus one, and wherein the number of columns in the first, second, and third vector is equal to one.

20. A computer program product for nonparametric entropy estimation, the computer program product comprising:
a non-transitory computer-readable medium comprising a set of codes for causing a computer to:
receive a sample having a sample size of two or more symbols;
calculate a number of distinct symbols in the sample, wherein the sample has one or more distinct symbols;
calculate a relative frequency for each of the one or more distinct symbols;
calculate a set of numerical terms for a plurality of pairs having a first and second value, wherein the set of numerical terms is calculated for each pair;
calculate a third value for each of the plurality of pairs, wherein the third value is denoted as at least one value in a first matrix;
calculate one or more fourth values for each column in the first matrix, wherein a fourth value is calculated for each value in the column, and wherein the fourth value is denoted as at least one value in a second matrix;
calculate a fifth value for each row in the second matrix, wherein the fifth value is denoted as at least one value in a first vector, and wherein the vector has one or more components;
calculate a sixth value for each component in the first vector, wherein the sixth value is denoted as at least one value in a second vector, and wherein the second vector has one or more components;
calculate a seventh value for each component in the second vector, wherein the seventh value is denoted as at least one value in a third vector, and wherein the third vector has one or more components; and
calculate an entropy estimation based at least partially on the one or more components in the third vector.
